(19) United States
(12) Patent Application Publication
(10) Pub. No.: US 2006/0028931 A1
(43) Pub. Date: Feb. 9, 2006

(54) Optical head device

(76) Inventor: Tatsuki Wade, Nagano (JP)

Correspondence Address: CANTOR COLBURN, LLP, 55 GRIFFIN ROAD SOUTH, BLOOMFIELD, CT, 06002, US

(21) Appl. No.: 11/198,604

(22) Filed: Aug. 5, 2005

(30) Foreign Application Priority Data
Aug. 9, 2004 (JP) 2004-232721

(51) Int. Cl. G11B 7/00

(52) U.S. Cl. 369/44.14; 369/112.01

(57) ABSTRACT

An optical head device includes a laser beam emitting element, a light receiving element, an optical system which guides an emitted light beam from the laser beam emitting element to the optical disk and guides the reflected light beam from the optical disk to the light receiving element, and a main body frame on which the laser beam emitting element, the light receiving element and the optical system are mounted. The main body frame is constructed of a metal frame and a resin frame. The optical system, the laser beam emitting element and the light receiving element are attached to the metal frame and the metal frame is attached to the resin frame.

### CROSS REFERENCE TO RELATED APPLICATION

The present invention claims priority under 35 U.S.C. §119 to Japanese Application No. 2004-232721 filed Aug. 9, 2004, which is incorporated herein by reference.

### FIELD OF THE INVENTION

An embodiment of the present invention may relate to an optical head device for performing recording and reproduction in and from an optical disk such as a CD or a DVD. More specifically, an embodiment of the present invention may relate to the structure of a main body frame of the optical head device.

### BACKGROUND OF THE INVENTION

An optical head device which performs recording and reproduction in and from an optical disk such as a CD or a DVD includes a laser beam emitting element which emits a laser beam to the optical disk, a light receiving element which receives a reflected light from the optical disk, an optical system which guides the emitted light beam from the laser beam emitting element to the optical disk and guides the reflected light beam from the optical disk to the light receiving element, and the like. These laser beam emitting element, light receiving element and optical system are mounted on a main body frame. The main body frame made of metal or resin may be used but an inexpensive main body frame made of resin is widely used to reduce its cost.

In recent years, a laser beam emitting element with a high output performance has been used as the recording density of an optical disk or the recording speed becomes higher. The heat-generating amount from the laser beam emitting element is also increased due to the high-output performance of the laser beam emitting element and thus the heat radiation is important. Especially, the heat radiation property of the resin body frame is inferior to that of a metal body frame. Therefore, in the optical head device using the resin body frame, various measures for heat radiation have been proposed.

For example, an optical head device has been proposed in which a wiring circuit board having a double structure is fixed on the bottom face of a resin main body frame. The wiring circuit board is constructed such that a resin board is stuck on a metal base member with an adhesive to have the double structure (see, for example, Japanese Patent Laid-Open No. 2003-67944). In the optical head device described in this prior art, a laser beam emitting element, a light receiving element and prescribed optical elements constructing an optical system are adhesively fixed to a frame for positioning components which is made of photosensitive glass or resin material. In this state, these elements are mounted on the wiring circuit board and the heat generated by the laser beam emitting element is radiated through the wiring circuit board.

As a structure for further increasing the heat radiation effect, an optical head device has been also proposed which is provided with a wiring circuit board having another double structure instead of the wiring circuit board described in the above-mentioned prior art. This wiring circuit board is constructed such that a metal plate on which wiring patterns are formed is adhesively stuck on a metal base member (see, for example, Japanese Patent Laid-Open No. 2002-269791). Since the wiring circuit board described in this prior art is constructed in the double structure in which two metal members are sandwiched, the heat generated in the laser beam emitting element can be further effectively radiated through the wiring circuit board.

However, in the optical head devices described in the above-mentioned prior arts, the laser beam emitting element, the light receiving element and the prescribed optical elements are mounted on the wiring circuit board in the state where they are adhesively fixed to the frame for positioning components made of photosensitive glass or resin material. Therefore, the above-mentioned prior arts have following problems. First, the rigidity of the frame is reduced by the effects of the heat generated in the laser beam emitting element and thus the shock resistance for the optical head device is reduced. Further, since the respective elements are adhesively fixed to the frame made of photosensitive glass or resin material, it is difficult to obtain a sufficient adhesive strength and the shock resistance of the optical head device decreases even at an ordinary temperature.

In order to eliminate the problems described above, an optical head device has been proposed in which a heat radiation plate made of metal is fixed on the bottom face of a resin main body frame and respective elements such as a laser beam emitting element, a light receiving element and prescribed optical elements are mounted on the heat radiation plate (see, for example, Japanese Patent Laid-Open No. 2001-307371). The respective elements are adhesively fixed on the metal heat radiation plate in the optical head device described in this prior art. The heat radiation plate on which the respective elements are fixed is metal and thus the lowering of rigidity of the heat radiation plate due to the effects of the heat generated in the laser beam emitting element is little. Therefore, the shock resistance in the optical head device is also not lowered. Further, when the respective elements are adhesively fixed to the metal plate, the adhesive strength is ensured in comparison with the case that the respective elements are adhesively fixed to a frame made of photosensitive glass or resin material. Therefore, the shock resistance is improved in the optical head device described in the latter prior art in comparison with the former prior arts.

In these days, the recording density and the recording speed in an optical head device has been increased. Therefore, a further high-output laser beam emitting element has been used and thus a further improved measure for the heat radiation is required. However, the heat radiation is not sufficient even in the structure of the optical head device which is disclosed in the latter prior art and thus a more effective measure for heat radiation is required.

### SUMMARY OF THE INVENTION

In view of the problems described above, the present invention may advantageously provide an optical head device which is capable of effectively radiating the heat generated in the laser beam emitting element while shock resistance is ensured.

Thus, according to embodiments of the present invention, there may be provided an optical head device including a laser beam emitting element which emits a laser beam toward an optical disk, a light receiving element which receives a reflected light beam from the optical disk, an optical system which guides an emitted light beam from the laser beam emitting element to the optical disk and guides the reflected light beam from the optical disk to the light receiving element, and a main body frame on which the laser beam emitting element, the light receiving element and the optical system are mounted. In the optical head device, the main body frame is constructed of a metal frame that is made of metal and a resin frame made of resin. To the metal frame are adhesively fixed prescribed optical elements which construct the optical system, the laser beam emitting element and the light receiving element, and the metal frame is fixed on the upper face of the resin frame so as to face the optical disk.

In accordance with an embodiment of the present invention, the main body frame is constructed of a metal frame that is made of metal and a resin frame made of resin and, in addition, prescribed optical elements which construct the optical system, the laser beam emitting element and the light receiving element are adhesively fixed to the metal frame. Since the reduction of rigidity of the metal frame due to the heat generation of the laser beam emitting element is almost ignored, the decreasing of shock resistance of the optical head device based on the heat generation of the laser beam emitting element is prevented and the adhesive strength is ensured and the shock resistance can be improved.

Further, at the time of driving the laser beam emitting element, in other words, when heat is generated by the laser beam emitting element, the optical disk is rotated and thus wind is generated by the rotation of the optical disk. In accordance with an embodiment of the present invention, since the metal frame is fixed on the upper face of the resin frame which faces the optical disk, the metal frame can be effectively cooled by the wind generated by the rotation of the optical disk. Especially, as the rotating speed of the optical disk becomes higher and higher, the airflow generated by the rotation of the optical disk increases and thus the metal frame can be further effectively cooled when the recording speed is increased.

In accordance with an embodiment of the present invention, the metal frame is preferably formed by using a one piece metal member. In this case, the structure of the optical head device can be simplified in comparison with the case that the respective elements are respectively adhesively fixed to a plurality of metal members. Further, in the structure that a plurality of metal members are respectively fixed to the resin frame, the deviation may occur between the mutual metal members due to the heat generated from the laser beam emitting element and thus the deviation may occur in the positional relationship between the respective elements. However, since the metal frame is formed of one piece of metal member, the positional deviations between the respective elements do not occur.

In accordance with an embodiment of the present invention, the prescribed optical elements mounted on the metal frame preferably includes a collimating lens for converting the emitted light beam from the laser beam emitting element into a parallel light beam. When the metal frame is formed of one piece of metal member and the collimating lens for converting the emitted light beam from the laser beam emitting element into a parallel light beam is mounted on the metal frame, the metal frame on which the respective elements are mounted can be regarded as one optical unit which emits the parallel light beam. Therefore, since the optical unit emits a parallel light beam, the adjustment of the mounting positions of the respective elements on the optical unit can be performed by using a prescribed jig in an off-line manner. As a result, the assembling operations for an optical head device are simplified and its manufacturing cost can be reduced.

In accordance with an embodiment of the present invention, the metal frame is preferably formed of sheet steel. In this case, the metal frame can be produced at a low cost by using a simple method such as press working.

In accordance with an embodiment of the present invention, the metal frame may be fixed between a secondary shaft, which makes a guide part formed in the resin frame slide to guide the optical head device in a radial direction of the optical disk, and an objective lens included in the optical system.

In accordance with an embodiment of the present invention, the prescribed optical elements constructing the optical system, the laser beam emitting element and the light receiving element are preferably fixed on the rear face of the metal frame which faces the upper face of the resin frame. In this case, the thickness of the optical head device can be reduced.

In accordance with an embodiment of the present invention, the laser beam emitting element is preferably a frame type of laser beam emitting element which is constructed such that a semiconductor laser chip is housed within a square frame. When the laser beam emitting element is adhesively fixed on the rear face of the metal frame and a frame type of laser beam emitting element is used, the thickness of the optical head device can be further reduced in comparison with a can type of laser beam emitting element which is constructed such that a semiconductor laser chip is housed in a cylindrical frame.

As described above, in the optical head device in accordance with an embodiment of the present invention, the respective elements, i.e., prescribed optical elements, the laser beam emitting element and the light receiving element are adhesively fixed on the metal frame. Since the reduction of rigidity of the metal frame due to the heat generation of the laser beam emitting element is almost ignored, the shock resistance of the optical head device is not decreased. Further, the adhesive strength is ensured and the shock resistance can be improved. Moreover, the metal frame is fixed on the upper face of the resin frame facing the optical disk. Therefore, the metal frame can be effectively cooled by the wind generated by the rotation of the optical disk. Accordingly, the heat generated in the laser beam emitting element mounted on the metal frame can be further effectively radiated.

Other features and advantages of embodiments of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic structural view showing an optical head device in accordance with an embodiment of the present invention.

FIG. 2 is a perspective view showing the optical head device shown in FIG. 1 which is viewed from an upper face side.

FIG. 3 is a perspective view showing the optical head device shown in FIG. 1 which is viewed from a bottom face side.

FIG. 4 is a perspective view showing a state where optical elements are mounted on a metal frame of the optical head device shown in FIG. 1 which is viewed from the bottom face side.

### DETAILED DESCRIPTION OF THE PREFERRED EMBODIMENTS

Several embodiments of the present invention will be described in detail below with reference to the accompanying drawings.

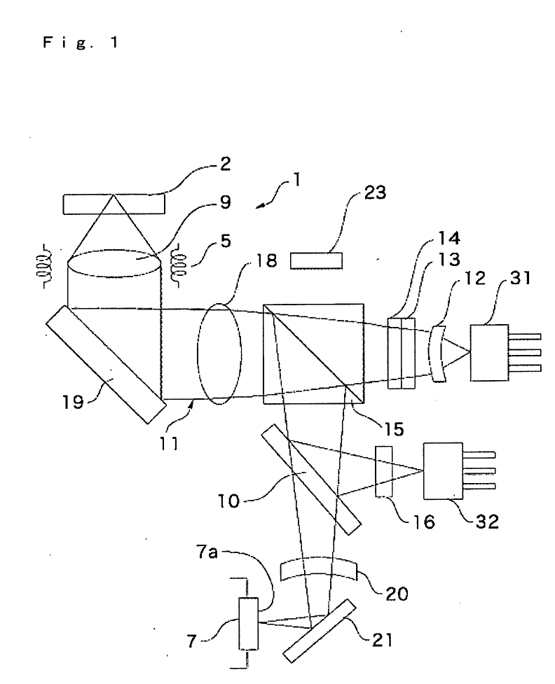

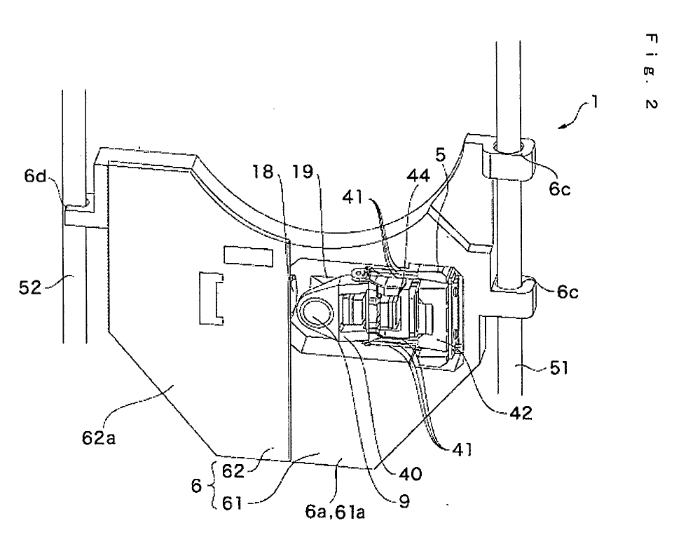

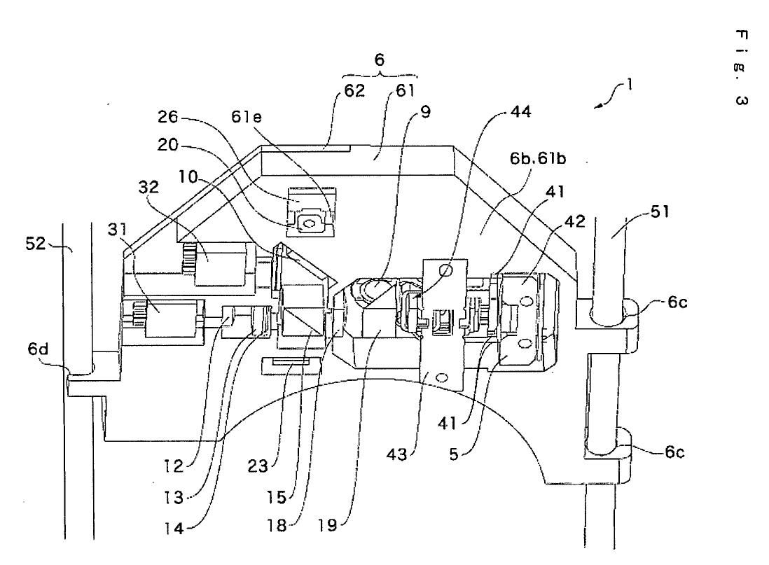

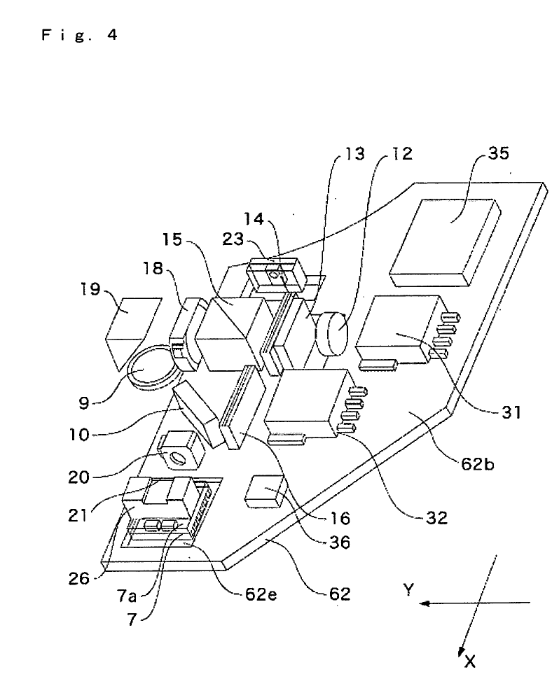

FIG. 1 is a schematic structural view showing an optical head device in accordance with an embodiment of the present invention. FIG. 2 is a perspective view showing the optical head device shown in FIG. 1 viewed from an upper face side. FIG. 3 is a perspective view showing the optical head device shown in FIG. 1 viewed from a bottom face side. FIG. 4 is a perspective view showing a state where optical elements are mounted on a metal frame of the optical head device shown in FIG. 1 viewed from the bottom face side.

An optical head device 1 in accordance with an embodiment of the present invention is used for recording and reproducing information in and from an optical disk 2 such as a CD or a DVD. The optical head device 1 includes a first and a second laser beam emitting elements 31, 32 as light sources for emitting laser beams to the optical disk 2, a light receiving element 7 for receiving the reflected light from the optical disk 2, and an objective lens drive device 5 which drives an objective lens 9 in the tracking direction, the focusing direction and the tilt direction for converging the emitted laser beam on the optical disk 2. The optical head device 1 also includes a main body frame 6 on which the objective lens drive device 5 is held on the upper face side of the main body frame 6. A prescribed optical system for guiding the emitted light beams from the first and the second laser beam emitting elements 31, 32 to the optical disk 2 and for guiding the reflected light beams from the optical disk 2 to the light receiving element 7 is mounted on the main body frame 6. The first and the second laser beam emitting elements 31, 32 and the light receiving element 7 are also mounted on the main body frame 6. The first and the second laser beam emitting elements 31, 32 are a laser beam emitting element for DVD which emits the first laser beam with a wavelength of 650 nm or 635 nm (short wavelength) and a laser beam emitting element for CD which emits the second laser beam with a wavelength of 760-800 nm (long wavelength). The first and the second laser beam emitting elements 31, 32 are a frame type of laser beam emitting element in which a semiconductor laser chip is housed within a square frame.

The first laser beam emitted from the first laser beam emitting element 31 is guided to a common optical path 11 directing to the optical disk 2 through a prism 15 which is a polarizing beam splitter as an optical path composing element and converged on the recording face of the optical disk 2 through the objective lens 9. The second laser beam emitted from the second laser beam emitting element 32 is guided to the common optical path 11 by a half mirror 10 and the prism 15 as an optical path splitting element and converged on the recording face of the optical disk 2 through the objective lens 9. The return light beam of the laser beam reflected by the optical disk 2 (reflected light) is incident on the half mirror 10 through the prism 15 and is separated by the half mirror 10 to be guided to the light receiving face 7a of the light receiving element 7.

More concretely, a relay lens 12, a ½ wavelength plate 13, a first grating lens 14, the prism 15, a collimating lens 18, a raising mirror 19 and the objective lens 9 are disposed in this order on the optical path directing to the optical disk 2 from the first laser beam emitting element 31 on the main body frame 6. Therefore, the first laser beam emitted from the first laser beam emitting element 31 transmits through the relay lens 12, the ½ wavelength plate 13, the first grating lens 14 and the prism 15, and then the first laser beam is converted into a parallel light beam by the collimating lens 18. After that, the first laser beam is guided upward with the raising mirror 19 and converged as an optical spot on the recording face of the optical disk 2 through the objective lens 9.

A second grating lens 16, the half mirror 10, the prism 15, the collimating lens 18, the raising mirror 19 and the objective lens 9 are disposed in this order on the optical path directing to the optical disk 2 from the second laser beam emitting element 32. Therefore, the second laser beam emitted from the second laser beam emitting element 32 transmits through the second grating lens 16, and then a part of the second laser beam is reflected by the half mirror 10 and reflected by the prism 15. The second laser beam is converted into a parallel light beam by the collimating lens 18, and then guided upward with the raising mirror 19 and converged as an optical spot on the recording face of the optical disk 2 through the objective lens 9.

The reflected light beam by the optical disk 2 is guided on the optical path in the reverse direction. In other words, the reflected light beam is guided to the prism 15 through the objective lens 9, the raising mirror 19, and the collimating lens 18 and then reflected by the prism 15 to be incident on the half mirror 10. After that, the light beam transmitted through the half mirror 10 transmits through the sensor lens 20, and then bent by a beam guide mirror 21 to reach to the light receiving face 7a of the light receiving element 7.

On one side of the prism 15 is provided a light receiving element 23 to monitor and provide feedback to adjust the outputs of the first and the second laser beam emitting elements 31, 32. The light receiving element 23 to monitor and provide feedback is disposed at a position where the light receiving element 23 receives the first laser beam which is emitted from the first laser beam emitting element 31 and partially reflected by the prism 15 and receives the second laser beam which is emitted from the second laser beam emitting element 32 and partially transmits through the prism 15.

Referring now to FIGS. 2 and 3, the main body frame 6 is constructed of a first frame 61 made of resin and a second frame 62 made of metal. The main body frame 6 is formed in a flat shape having an upper face 6a facing the optical disk 2 and a bottom face 6b which is the opposite face of the upper face 6a.

The first frame 61 is provided with an upper face 61a and a bottom face 61b. Guide holes 6c, which are circular holes and a guide part 6d which is protruded in a U-shape are formed on both end parts of the first frame 61. The optical head device 1 is capable of moving in a radial direction of the optical disk 2 along a main shaft 51 which is passed through the guide holes 6c, and a secondary shaft 52 which is passed through the guide part 6d. An aperture part 61e is formed in the first frame 61 so as to be capable of adjusting the mounting position of the light receiving element 7 from the bottom face 6b side (see FIG. 3).

The second frame 62 which is provided with an upper face 62a and a bottom face 62b is a flat plate member made of metal and having a high coefficient of thermal conductivity. Concretely, the second frame 62 is formed of a one piece metal member. For example, the second frame 62 is formed from sheet steel with press working. For example, the plate thickness from 0.6 mm to 0.8 mm is used as the sheet steel. The second frame 62 is disposed between the objective lens 9 and the secondary shaft 52 on the upper face 6a side of the main body frame 6. Further, the second frame 62 is fixed on the upper face 61a of the first frame 61 such that the upper face 61a of the first frame 61 and the bottom face 62b face each other.

In the second frame 62 is formed a placing face 62e (see FIG. 4) in a concaved shape on which the light receiving element 7 is mounted. A light receiving element placing part for mounting the light receiving element 7 is constructed with the placing face 62e and the aperture part 61e formed in the first frame 61. The second frame 62 may be formed by dies casting working such as zinc dies casting to reduce the weight of the second frame 62.

On the second frame 62 are mounted prescribed optical elements which construct the optical system, the first and the second laser beam emitting elements 31, 32, the light receiving element 7 and the like. Concretely, the prescribed optical system in an embodiment of the present invention includes the relay lens 12, the ½ wavelength plate 13, the first grating lens 14, the second grating lens 16, the prism 15, the half mirror 10, the collimating lens 18, the light receiving element 23 for monitoring and the sensor lens 20. These optical elements, the first and the second laser beam emitting elements 31, 32 and the light receiving element 7 are adhesively fixed and mounted on the rear face of the second frame 62. Therefore, the optical head device 1 can be made thinner than the device in which the first and the second laser beam emitting elements 31, 32 and the light receiving element 7 are disposed on the side face of the device. Further, on the second frame 62 are adhesively fixed and mounted a driver 35 for driving the first and the second laser beam emitting elements 31, 32 and a high-frequency current superimposing IC 36 for the first and the second laser beam emitting elements 31, 32. The raising mirror 19 is mounted on the first frame 61.

Solder land parts (not shown in the drawing) are formed on the rear face 62b of the second frame 62. An FPC (Flexible Printed Circuit, not shown in the drawing) which is a wiring circuit board is connected to the solder land parts. The second frame 62 serves as a pressure cover for the FPC in the state where the second frame 62 is fixed on the upper face 61b of the first frame 61.

On the placing face 62e of the second frame 62 is disposed the light receiving element 7 such that the light receiving face 7a faces the incident direction of the reflected light to the objective lens 9 (upward direction in FIG. 4). The mounting position of the light receiving element 7 is adjustable along the placing face 62e from the bottom face 6b side. Further, when the tracking direction of the optical disk 2 is set to be the X-direction and the direction parallel to the light receiving face 7a and perpendicular to the tracking direction is set to be the Y-direction, the mounting position of the light receiving element 7 is adjustable so as to be parallel with the light receiving face 7a in the two dimensional directions of the X-direction and the Y-direction.

On the light receiving face 7a of the light receiving element 7 is placed a mirror holder 26 on which the beam guide mirror 21 is mounted. The beam guide mirror 21 is disposed in the mirror holder 26 so as to bend the reflected light toward the light receiving face 7a. The mounting position of the beam guide mirror 21 is adjustable along the light receiving face 7a in one dimensional direction of the X-direction through the mirror holder 26. Further, the mounting position of the beam guide mirror 21 is adjustable from the bottom face 6b side through the mirror holder 26. The beam guide mirror 21 is a total reflection mirror in an embodiment of the present invention.

The objective lens drive device 5 includes a lens holder 40 which holds the objective lens 9, a holder support member 42 movably supporting the lens holder 40 in a tracking direction, a focusing direction and a tilt direction with six wires 41 such that both sides of the lens holder 40 are respectively supported by three wires which are disposed in the vertical direction, and a yoke 43 which constructs the frame for the objective lens drive device 5. The yoke 43 is attached on the bottom face 6b side of the main body frame 6. Therefore, the objective lens drive device 5 is mounted on the main body frame 6 such that the objective lens 9 is disposed on the upper face 6a side of the main body frame 6. The holder support member 42 is fixed to and supported by the main body frame 6 or the yoke 43.

The objective lens drive device 5 is provided with a magnetic drive circuit 44 which is constructed by drive coils mounted on the lens holder 40 and drive magnets mounted on the yoke 43. The objective lens 9 supported by the lens holder 40 can be driven in the tracking direction, the focusing direction and the tilt direction with respect to the optical disk 2 by controlling energization to the drive coils.

As shown in FIG. 2, the center of gravity of the objective lens drive device 5 is located between the objective lens 9 and the main shaft 51. The second frame 62 is disposed between the objective lens 9 and the secondary shaft 52 and the area of the upper face 62a of the second frame 62 is approximately half of that of the upper face 61a of the first frame 61. In other words, the center of gravity of the second frame 62 is disposed between the objective lens 9 and the secondary shaft 52. In the case that the main body frame 6 is constructed by using a lightweight frame made of resin, the weight balance of the main body frame becomes a problem. However, in an embodiment of the present invention, the center of gravity of the objective lens drive device 5 and the center of gravity of the second frame 62 are disposed so as to be across the objective lens 9 and thus a preferable weight balance of the optical head device 1 is obtained.

An adjusting method of the mounting position of the light receiving element 7 in the optical head device 1 as constructed above will be described below.

In an embodiment of the present invention, the collimating lens 18 for converting the emitted light beams from the first and the second laser beam emitting elements 31, 32 into a parallel light beam is mounted on the second frame 62. Therefore, the second frame 62 on which the prescribed optical elements are mounted can be regarded as one optical unit which emits the parallel light beam. Accordingly, in an embodiment of the present invention, the mounting position of the light receiving element 7 is adjusted in an off-line manner, in other words, in the state before the second frame 62 is fixed to the first frame 61.

In order to adjust the mounting position of the light receiving element 7 in an off-line manner, a pseudo disk (not shown in the drawing) provided with a reflection face which reflects a laser beam is used instead of the optical disk 2. Further, an adjusting mirror (not shown in the drawing) for raising the laser beam emitted from the collimating lens 18 and an adjusting lens (not shown in the drawing) for converging the laser beam raised by the adjusting mirror are used.

The pseudo disk is, for example, a mirror which is disposed on the optical axis of the light beam emitted from the adjusting lens. The pseudo disk is only required to reflect the laser beam that is emitted from the adjusting lens and thus a small disk can be used in comparison with the optical disk 2. The focal depth of the adjusting lens is larger than that of the objective lens 9. The mounting position of the light receiving element 7 is adjustable by using the adjusting lens even when the mounting accuracy of the pseudo disk in the focusing direction cannot be sufficiently secured.

The mounting position of the light receiving element 7 is adjusted by using the pseudo disk, the adjusting mirror and the adjusting lens in an off-line manner. Concretely, the second frame 62 on which the optical elements except the light receiving element 7 and the beam guide mirror 21, the first and the second laser beam emitting elements 31, 32 are adhesively fixed, the adjusting mirror, the adjusting lens and the pseudo disk are held by a prescribed jig.

After that, the laser beams are successively emitted from the first and the second laser beam emitting elements 31, 32 and the mounting position of the light receiving element 7 is adjusted while the reflected light from the pseudo disk is detected. More concretely, while the light receiving element 7 is adjusted along the placing face 62e and in parallel with the light receiving face 7a in two dimensional directions (X-direction and Y-direction), the position of the mirror holder 26 is adjusted along the light receiving face 7a and in parallel with the light receiving face 7a in one dimensional direction (X-direction) by using a prescribed jig. As a result, the optical axis of the reflected light which is incident on the light receiving face 7a is matched to the optical axis of the light receiving face 7a and the optical path length of the reflected light reaching to the light receiving face 7a is adjusted. This position adjustment is performed from the bottom face 6b side of the main body frame 6.

When the adjustment of mounting position of the light receiving element 7 has been completed, the light receiving element 7 is fixed to the second frame 62 with an adhesive and the mirror holder 26 is fixed to the light receiving face 7a of light receiving element 7 with an adhesive. In this manner, the second frame 62 on which the prescribed optical elements are mounted is fixed on the upper face of the first frame 61 in the state that the mounting position of the light receiving element 7 has been completed, and the raising mirror 19 and the objective lens drive device 5 are mounted on the first frame 61. As a result, the optical head device 1 is completed.

As described above, in the optical head device 1 in accordance with an embodiment of the present invention, the main body frame 6 is constructed of the first frame 61 made of resin and the second frame 62 made of metal, and the respective elements, i.e., prescribed optical elements such as the prism 15 and the collimating lens 18 constructing the optical system, the first and the second laser beam emitting elements 31, 32, and the light receiving element 7 are fixed to the second frame 62 with an adhesive. Since the second frame 62 is made of metal, the reduction of rigidity of the second frame 62 due to the heat generation of the first and the second laser beam emitting elements 31, 32 can be almost ignored. Therefore, the lowering of the shock resistance of the optical head device 1 due to the heat generation of the first and the second laser beam emitting elements 31, 32 is prevented. Further, since the respective elements are adhesively fixed to the second metal frame 62, the adhesive strength is ensured and the shock resistance can be improved, for example, in comparison with the case that the respective elements are adhesively fixed to the frame made of resin.

Further, at the time of driving the first and the second laser beam emitting elements 31, 32, in other words, when heat is generated by the first and the second laser beam emitting element 31, 32, the optical disk 2 is rotated and thus wind is generated with the rotation of the optical disk 2. In an embodiment of the present invention, since the second frame 62 is fixed on the upper face of the first frame 61 which faces the optical disk 2, the second frame 62 can be effectively cooled by the wind generated by the rotation of the optical disk 2. Especially, as the rotating speed of the optical disk 2 becomes higher and higher, the airflow generated by the rotation of the optical disk 2 also increases and thus the second frame 62 can be further effectively cooled as the recording speed is increased. Therefore, even when the heat-generating amount of the first and the second laser beam emitting elements 31, 32, which are mounted on the second frame 62, is increased, the heat generation can be more effectively radiated.

In addition, since the area of the upper face 62a of the second frame 62 is approximately half of that of the upper face 61a of the first frame 61, the heat can be efficiently radiated from the second frame 62.

In an embodiment of the present invention, the second frame 62 is formed of a one piece metal member. Therefore, the structure of the optical head device 1 can be simplified in comparison with the case that the prescribed optical elements and the first and the second laser beam emitting elements 31, 32 and the like are respectively adhesively fixed to a plurality of metal members. Further, in the structure that a plurality of metal members are respectively fixed to the first frame 61, a deviation may occur between the mutual metal members due to the heat generated from the first and the second laser beam emitting elements 31, 32, and thus a deviation may occur in the positional relationship between the respective elements. However, in an embodiment of the present invention, since the second frame is formed of a one piece metal member, positional deviations between the respective elements are minimized or do not occur.

In an embodiment of the present invention, the optical elements mounted on the second frame 62 includes the collimating lens 18 converting the emitted light beams from the first and the second laser beam emitting elements 31, 32 into the parallel light beam. Therefore, the second frame 62 on which the prescribed optical elements are mounted can be regarded as one optical unit which emits a parallel light beam. Since the optical unit emits a parallel light beam, the mounting position of the light receiving element 7 in this optical unit can be adjusted in an off-line manner by using prescribed jigs such as a pseudo disk, an adjusting mirror and an adjusting lens. In this case, the adjustment of the mounting position of the light receiving element 7 is not required after the second frame 62 is fixed to the first frame 61. In other words, the adjustment of the mounting position of the light receiving element 7 is completed without the first frame 61 which may cause an obstacle at the time of the adjustment of the mounting position of the light receiving element 7. Therefore, the adjusting operations of the mounting position of the light receiving element 7 are simplified and, as a result, the manufacturing cost can be reduced.

In an embodiment of the present invention, the second frame 62 is formed of sheet steel. Therefore, the second frame 62 can be produced at a low cost by using a simple method such as press working.

In an embodiment of the present invention, the prescribed optical elements constructing the optical system, the first and the second laser beam emitting elements 31, 32 and the light receiving element 7 are fixed on the rear face 62b of the second frame 62, which faces the upper face 61a of the first frame 61, and thus the thickness of the optical head device 1 can be reduced. Especially, in an embodiment of the present invention, the first and the second laser beam emitting elements 31, 32 are respectively a frame type of laser beam emitting element that is constructed such that a semiconductor laser chip is housed within a square frame. Therefore, the thickness of the optical head device 1 can be further reduced in comparison with a can type of laser beam emitting element which is constructed such that a semiconductor laser chip is housed within a cylindrical frame. Alternatively, when the optical head device 1 is not required to be thin, a can-type of laser beam emitting element may be used for the first and the second laser beam emitting elements 31, 32.

The present invention is not limited to the embodiments described above, and many modifications can be made without departing from the subject matter of the present invention. For example, in the above-mentioned embodiment, the second frame 62 is formed of a one piece metal member but the second frame 62 may be formed of a plurality of metal members, for example, a plurality of sheet steels.

Further, wiring circuit patterns may be formed on the rear face 62b of the second frame 62 and various electronic components are mounted on the surface of the second frame 62 so as to be connected to the wiring circuit patterns. In addition, solder lands are provided on the upper face 62a of the second frame 62 and a FPC as a wiring circuit board may be connected to the solder lands.

Moreover, the mounting position of the light receiving element 7 is not always required to be adjusted in an off-line manner. The adjustment of the mounting position of the light receiving element 7 may be performed in the state of the completed optical head device 1 and the optical disk 2.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device comprising:
a laser beam emitting element which emits a laser beam toward an optical disk;
a light receiving element which receives a reflected light beam from the optical disk;
an optical system which guides an emitted light beam from the laser beam emitting element to the optical disk and guides the reflected light beam from the optical disk to the light receiving element; and
a main body frame on which the laser beam emitting element, the light receiving element and the optical system are mounted, the main body frame being constructed of a metal frame that is made of metal and a resin frame made of resin;
wherein prescribed optical elements which construct the optical system, the laser beam emitting element and the light receiving element are adhesively fixed to the metal frame and the metal frame is fixed on an upper face of the resin frame so as to face the optical disk.

2. The optical head device according to claim 1, wherein the metal frame is formed by using a one piece metal member.

3. The optical head device according to claim 2, wherein the prescribed optical elements mounted on the metal frame includes a collimating lens for converting the emitted light beam from the laser beam emitting element into a parallel light beam.

4. The optical head device according to claim 1, wherein the metal frame is formed of sheet steel.

5. The optical head device according to claim 1, wherein the metal frame is fixed between a secondary shaft, which slides with a guide part formed in the resin frame to guide the optical head device in a radial direction of the optical disk, and an objective lens included in the optical system.

6. The optical head device according to claim 1, wherein the prescribed optical elements constructing the optical system, the laser beam emitting element and the light receiving element are fixed on a rear face of the metal frame which faces an upper face of the resin frame.

7. The optical head device according to claim 6, wherein the laser beam emitting element is a frame type of laser beam emitting element which is constructed such that a semiconductor laser chip is housed within a square frame.

8. The optical head device according to claim 6, wherein an upper face of the metal frame faces the optical disk such that the metal frame is cooled by wind which is generated by rotation of the optical disk.

9. An optical head device for use with an optical disk comprising:
at least one laser beam emitting element;
a light receiving element which receives light emitted from the laser emitting element;
an optical system which guides light from the laser to an optical disk and guides light reflected from the optical disk to the light receiving element;
a main body frame comprising a metal frame made of metal and a resin frame made of resin, wherein the optical system, the at least one laser beam emitting element and the light receiving element are attached to the metal frame.

10. The optical head device of claim 9, wherein:
the metal frame is positioned on an optical disk side of the resin frame.
